(19) United States
(12) Patent Application Publication
(10) Pub. No.: US 2015/0225004 A1
(43) Pub. Date: Aug. 13, 2015

(54) Collapsible Rolling Cart

(71) Applicant: Bryan P. Dunford, Johns Creek, GA (US)

(72) Inventor: Bryan P. Dunford, Johns Creek, GA (US)

(21) Appl. No.: 14/176,827

(22) Filed: Feb. 10, 2014

(51) Int. Cl. B62B 3/02; B42F 15/00

(52) U.S. Cl. CPC B62B 3/02; B42F 15/0094

(57) ABSTRACT

Collapsible, substantially pre-assembled carts include a collapsible folding cart for hanging files with folding assemblies at each end of the cart, such ends being folded inwardly to a stored position and moveable to a deployed open position. Locking members removably are attached to folding assemblies and maintain the folding assemblies in a deployed position and such members are between spaced elongated legs, which have a caster on the lower ends thereof. A horizontal support is removably attached to the legs adjacent to the casters and remote from the locking members. Each locking member includes a handle generally medial thereof with a handhold usable to maneuver the cart. The locking member may include a rigid planar member or a U-shaped rigid member with spaced slots or keyholes that connect to spaced headed pins on the folding assemblies.

### FIELD OF THE INVENTION

The present invention relates to storage devices and more particularly to movable carts.

### BACKGROUND

The statements in this section merely provide background information related to the present invention and may not constitute prior art.

Carts, such as filing carts, are typically sold in a pre-assembled form or a form that requires some assembly. Pre-assembled carts are expensive to ship due to the volume a fully assembled cart occupies. Although a cart which requires assembly after purchase occupies less volume and may be less expensive to ship, it is time consuming to assembly many existing carts. Furthermore, many carts require additional tools to assemble, further complicating the assembly process. Many pre-assembled carts, as well as carts requiring initial assembly, cannot be disassembled, folded, or otherwise have their footprint easily reduced when the cart is not in use.

U.S. Pat. No. 6,443,481 granted on Sep. 3, 2002 to Stravitz, et al., discloses a movable cart having a collapsible frame configured to form a narrow lateral profile in a stored position and unfolded into an open position. The Stravitz cart comprises hinged side arms and a hinged tray interconnecting four cart legs. The top of the Stravitz cart is adapted to support a container.

Given the foregoing, what is needed are carts which are easy to ship and assemble. Additionally, carts are needed which are easy to store while having superior rigidity when in a deployed condition.

### SUMMARY

This Summary is provided to introduce a selection of concepts in a simplified form that are further described below in the Detailed Description. This Summary is not intended to identify key features or essential features of the subject matter to be claimed, nor is it intended to be used to limit the scope of the subject matter to be claimed.

The present disclosure is directed to carts which may be shipped in a substantially assembled, thin-form factor and assembled after shipping or purchase. In some aspects, no tools are required to assemble carts in accordance with the present disclosure.

In an aspect, a collapsible cart is disclosed which is designed to support and transport hanging files and may be folded into a stored position, allowing the cart to occupy a minimal amount of space when not being used. Furthermore, the cart may be shipped cost effectively in a thin form factor box. The collapsible cart includes folding assemblies at each end of the cart which may be folded from a stored position to a deployed position, locking members which removably attach to folding assemblies and maintain the folding assemblies in a deployed position, legs, wheels or casters, and a horizontal support removably attached to the legs of the cart. Each locking member preferably includes a handle usable to maneuver the cart. The cart sides respectively include a pair of elongated spaced channels which receive hanging file ends, enabling storage of hanging files within the cart without the provision of a filing tote or tub, as in Stravitz et al.

In some aspects of the present disclosure, the cart includes one or more locking wheels or casters.

In an aspect of the present disclosure, the locking member is a U-shaped rigid member having a handle and slots adapted to accept pins. The folding member is equipped with spaced pins. The locking member slides over a top portion of the folding member and engages the pins when the folding member is in a deployed position, thereby locking the folding member into place and providing structural reinforcement between the legs.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a perspective view of an assembled collapsible cart, in accordance with an aspect of the present invention;

FIG. 2 is a perspective view of a collapsible cart with the locking members and horizontal support exploded therefrom, in accordance with an aspect of the present invention;

FIG. 3 is a perspective view of a collapsible cart being folded via folding assemblies;

FIG. 4 is a perspective view of a collapsible cart in folded configuration;

FIG. 5 is a top view of a collapsible cart;

FIG. 6 is a top view of a collapsible cart wherein locking members have been removed;

FIG. 7 is a top view of a collapsible cart being folded via folding assemblies;

FIG. 8 is a top view of a collapsible cart in folded configuration;

FIGS. 9A-C are various views of a collapsible cart detailing a locking member having a U-configuration, in accordance with an aspect of the present invention;

FIGS. 10A-C are various views a collapsible cart detailing a locking member having a flat configuration, in accordance with an aspect of the present invention; and

FIG. 11 is a perspective view of a square collapsible cart having solid sides, in accordance with an aspect of the present invention.

### DETAILED DESCRIPTION

The present disclosure is directed to collapsible carts, including collapsible hand carts for hanging file folders. Devices in accordance with the present disclosure may be shipped, sold, stored, or transported in a folded configuration, enabling more efficient space utilization. Furthermore, collapsible carts of the present invention may be assembled by users without additional hand tools.

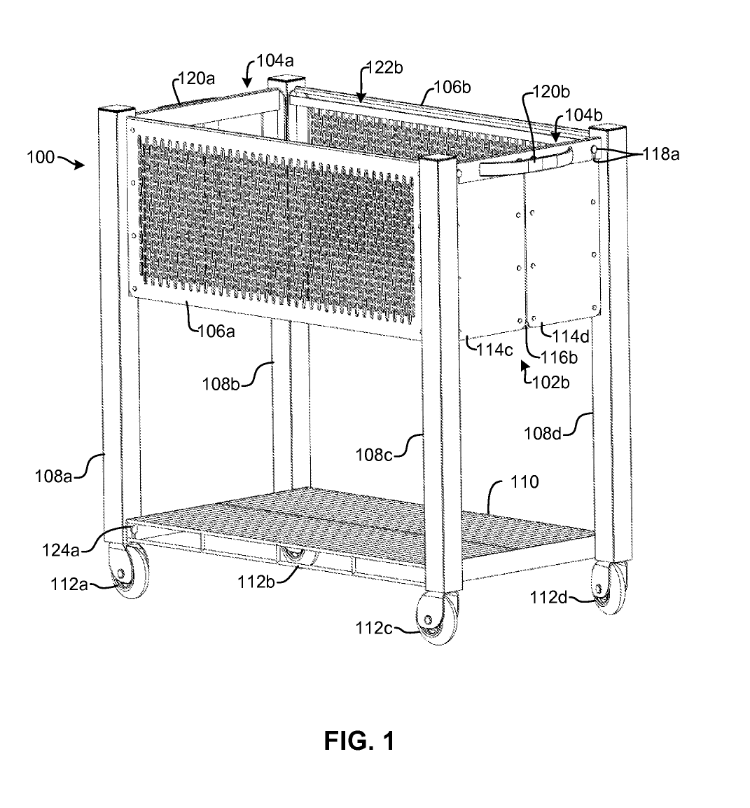

Referring now to FIG. 1, a perspective view of an assembled collapsible cart 100, in accordance with an aspect of the present invention, is shown.

Collapsible cart 100 includes a pair of folding assemblies 102a-b, locking members 104a-b, static sides 106a-b, a horizontal support 110, and wheels 112a-d.

Folding assembly 102 is a movable member which can be transformed from a folded position (shown in, FIG. 4) to a deployed position (shown in, FIG. 1). In the deployed position, folding assembly 102 spaces apart sides 106, thereby providing structure to cart 100. In an aspect, when in the deployed configuration, cart 100 is approximately as wide as a filing cabinet for holding hanging files. Each folding assembly 102 includes two hollow box legs 108a-d and two panels 114 (labeled, for clarity, only as panels 114c-d in FIG. 1) interconnected by an inner hinge 116 (labeled, for clarity, only as inner hinge 116b in FIG. 1) and connected to legs 108 via outer hinges 600 (shown in more detail in FIG. 6). As will be apparent to one skilled in the relevant art(s) after reading the description herein, inner hinge 116 may be a separate member such as a piano hinge, or the panel ends may be formed as interweaved hinge ends with a pivot rod interconnecting which interconnects and moves panels 114 from a deployed to a stored position, one way hinge, a locking rotation member and the like. Folding assembly 102 may additionally include one or more handles, hangars, loops, attachment points, and the like.

Locking member 104 is attachable to folding assembly 102, maintaining folding assembly 102 in a deployed position when attached. Locking member 104 attaches to folding assembly 102 via two or more spaced locking member connectors 118 (labeled, for clarity, only as connector 118a in FIG. 1). Locking member 104 connects to and extends across both panels 114, locking them in position and thereby locking folding assembly 102 in the deployed position. Locking member 104 extends the width of folding assembly 102 and is a snug fit between the spaced legs 108c-d.

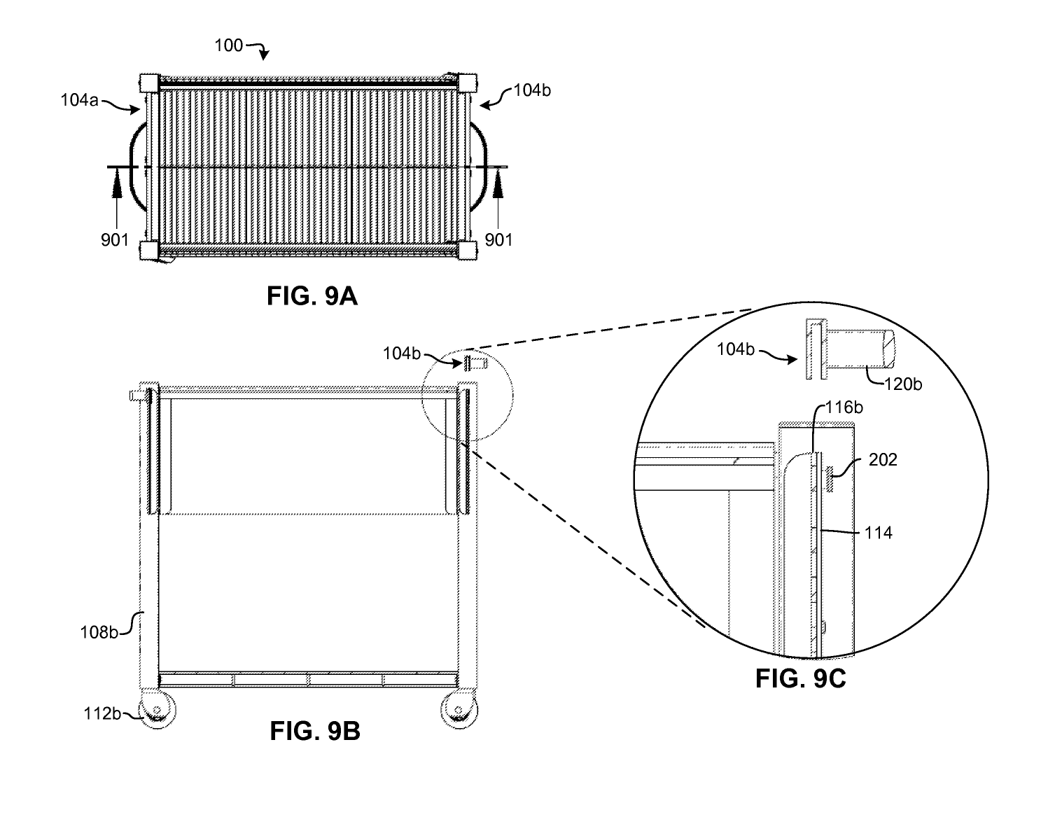

In an aspect, locking member 104 is a U-shaped rigid member, shown more clearly in FIGS. 9B-C, and attachable by placing locking member 104 over a top portion of folding assembly 104. In this manner, the folding assembly 102 may be locked in the deployed position, thereby spacing static sides 106a-b apart.

Locking member 104 preferably includes handle 120b which is arcuately shaped to provide a hand hold. Even if locking member 104 has no handle per se, locking member 104 is gripable by a hand of a user to maneuver the cart.

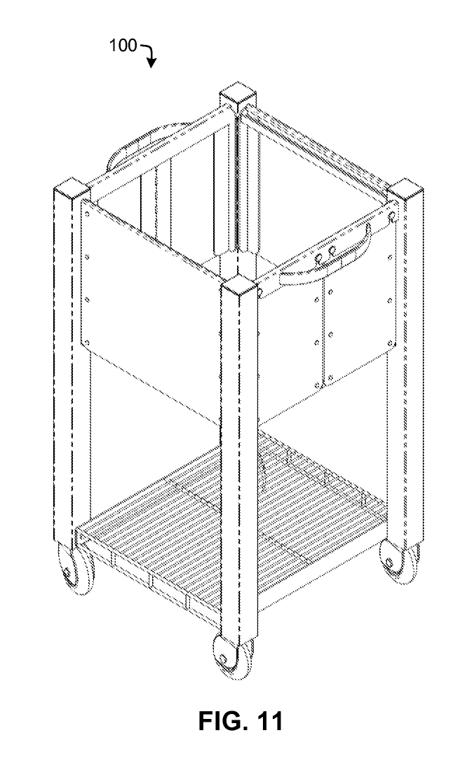

Static side 106 is a rigid member which provides structure to cart 100. Static side 106 may be a perforated or a solid member (as shown in FIG. 11). As will be apparent to one skilled in the relevant art(s) after reading the description herein, side 106 may be a variety of lengths, heights, or configurations. In an aspect, each static side 106 includes channel 122 (labeled, for clarity, only as channel 122b in FIG. 1). Channel 122 is a rigid member adapted to hold the ends of hanging files.

Horizontal support 110 is attachable to cart 102 via one or more support connectors 124 on each leg 108a-d (labeled, for clarity, only as support connector 124a in FIG. 1). Horizontal support 110 provides structural support to the lower portion of legs 108a-d. Horizontal support 110 may be a flat platform. In another aspect, horizontal support 110 may be formed as a frame or cross beams. Horizontal support 110 is removable and attaches to legs 108 at horizontal support attachment connectors 124 which are identical to connectors 118 hereafter described.

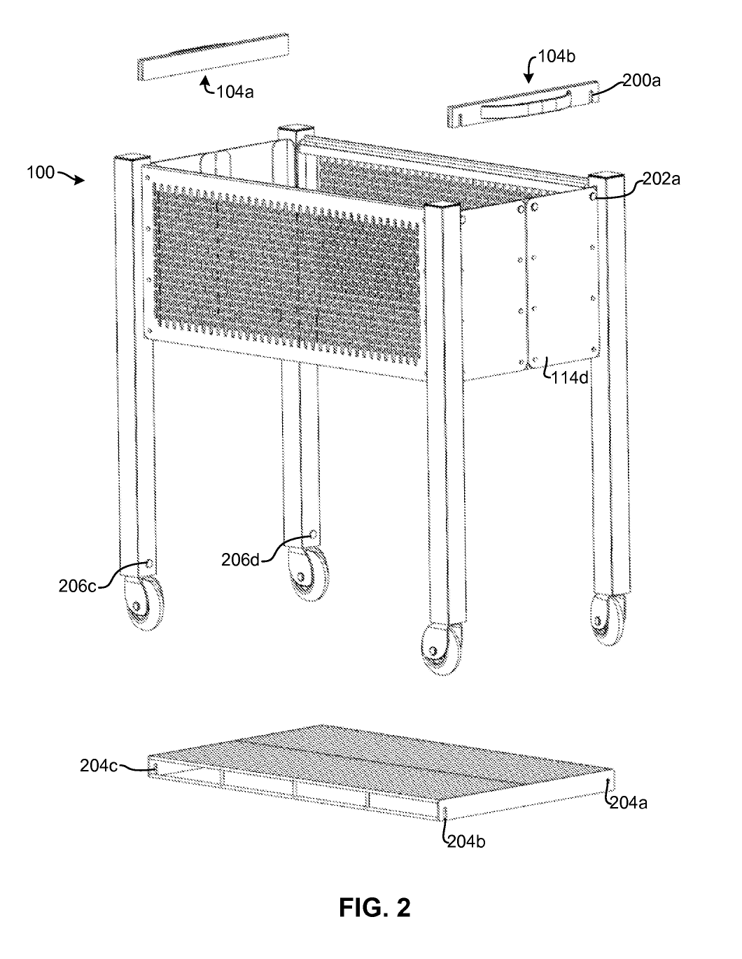

Referring now to FIG. 2, an exploded perspective view of cart 100 is shown, in accordance with an aspect of the present invention, is shown.

In an aspect, locking member 104 attaches to panels 114 via spaced two more locking member connectors 118. Four spaced locking member connectors 118 attach locking member 104 to panels 114.

Locking member connector 118 includes an open ended slot 200 (labeled, for clarity, only as slot 200a in FIG. 2) and a headed pin 202 (labeled, for clarity, only as pin 202a in FIG. 2). Slot 200 is formed in locking member 104. Pin 202 is preferably a headed pin having a shank affixed to panel 114 and a head spaced therefrom and extending parallel thereto. Slot 200 receives pin 202, thereby interconnecting locking member 104 and folding assembly 102. In another aspect, locking member connector 118 includes a keyhole slot and may include another fastener or connector apparent to one skilled in the relevant art(s) after reading the description herein.

In another aspect, locking member connectors 118 possibly may be omitted if U-shaped and placed over a portion of panels 114 and wedged between the legs 108c-d, thereby interlocking panels.

Cart 100 may further include two or more, preferably four wheels, or castors 112. Wheel 112 may be unidirectional or swivel. Wheel 112 may additionally comprise a wheel lock.

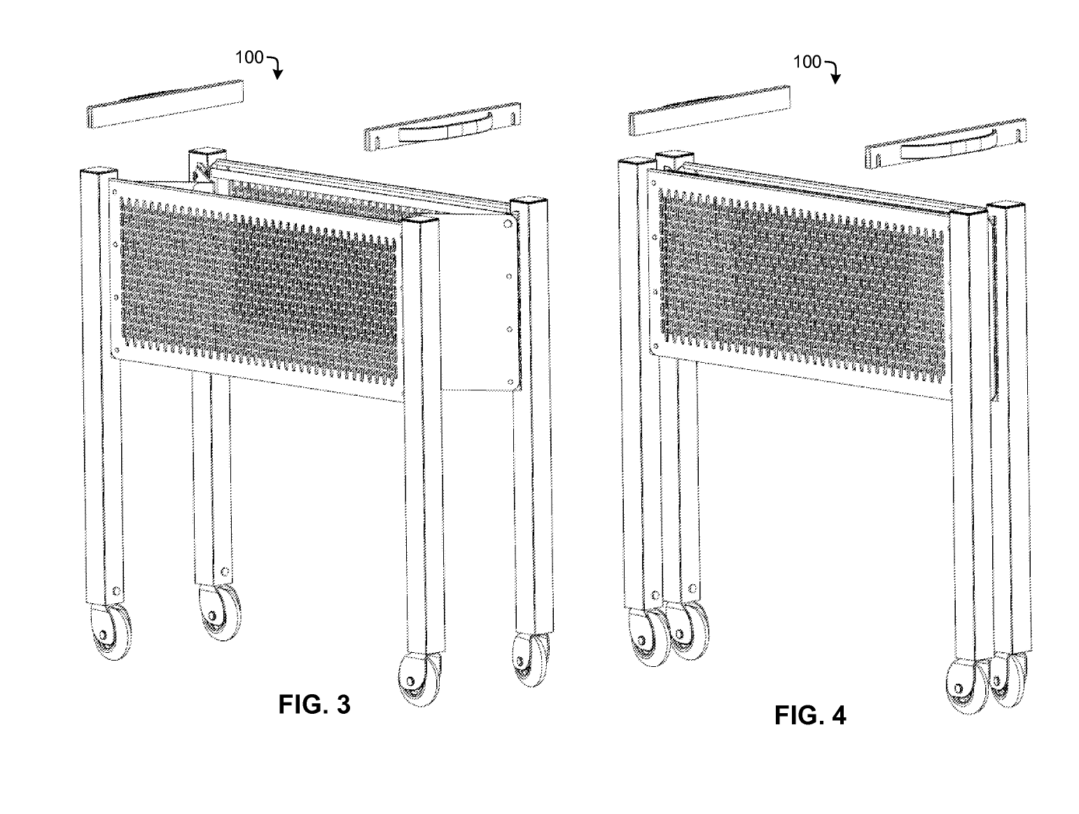

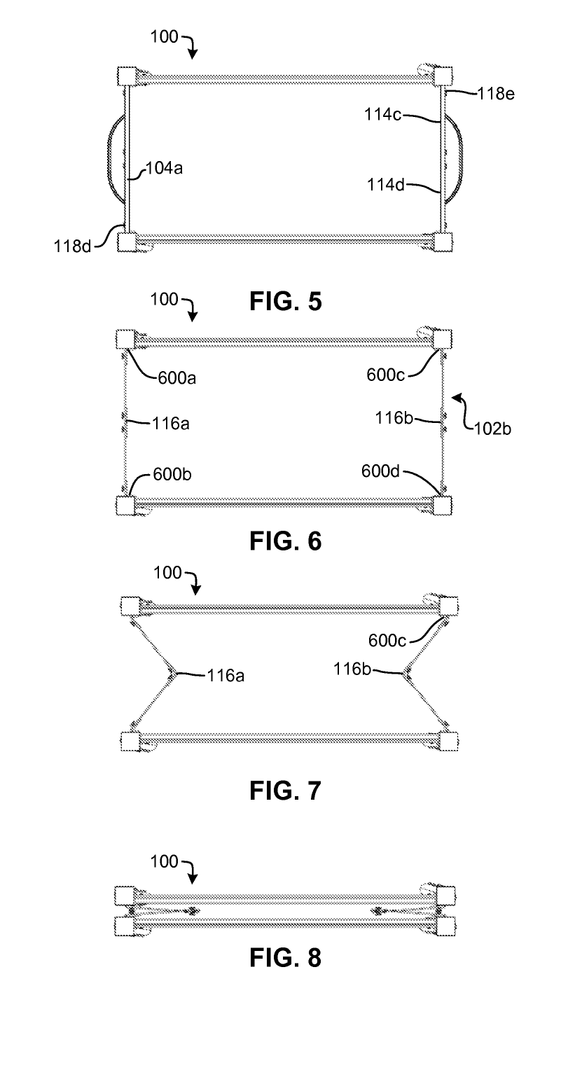

Referring now to FIGS. 3-8, various perspective views depict the collapsible cart 100 being folded via folding assemblies 102, in accordance with an aspect of the present disclosure, are shown.

Folding assembly 102 includes inner hinge 116 and two outer hinges (labeled as outer hinges 600a-d in FIG. 6). Outer hinges 600 connect folding assembly 102 to legs 108 and allow panels 114 to pivot relative to legs. In an aspect, outer hinges 600 are of the same design as inner hinge 116, thereby reducing the unique part count of cart 100 and simplifying manufacturing. In another aspect, outer hinges 600 are one way hinges, another type of movable member, or configured in another manner apparent to those skilled in the relevant art(s) after reading the description herein. In an aspect, legs 108 may further include one or more physical stops which limit the outward movement of panels 114.

Referring now to FIGS. 9A-C, various views of collapsible cart 100 are shown detailing the locking member 104 having a U-configuration, in accordance with an aspect of the present invention.

As shown in the detailed view of FIG. 9C, the cart is cut along cut line 901-901, and depicts the locking member 104 as a U-shaped member having two arm portions separated by a distance equal to the width of panel 114, plus a tolerance to allow a sliding fit as well as the thickness of the hinges. Pin 202 retains locking member 104 by interfacing with slot 308.

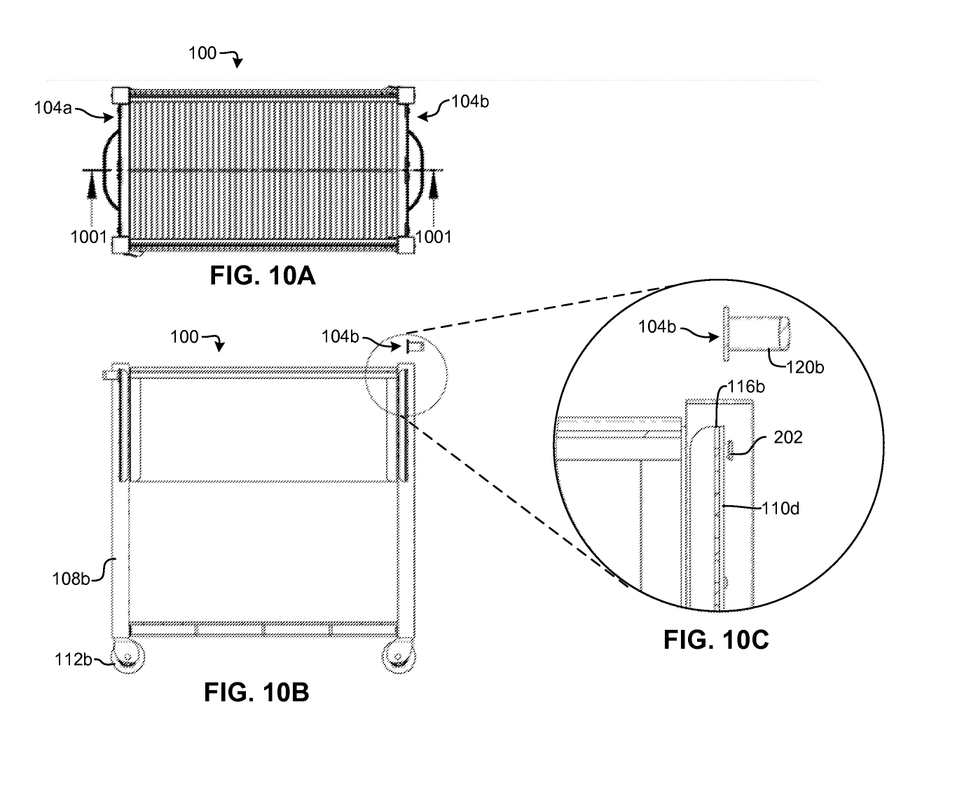

Referring now to FIGS. 10A-C, various views of the collapsible cart 100 detailing locking member 104 with a flat configuration are shown, in accordance with an aspect of the present disclosure.

In the detailed view of FIG. 10C, in another aspect, locking member 104 is configured as a flat member. Locking member 104 locks onto folding member 102 via locking member connector 118, such as slot 200 and pin 202.

Locking members 104 of the U-shaped configuration, the flat configuration, or another configuration apparent to those skilled in the relevant art reinforces the structure of cart 100 when cart 100 is in the deployed position. In particular, folding member 102 is reinforced and held in the deployed position by locking member 104.

FIG. 11 depicts the cart 100 in a square construction rather than the rectangular configuration of the other figures.

While various aspects of the present disclosure have been described above, it should be understood that they have been presented by way of example and not limitation. It will be apparent to persons skilled in the relevant art that various changes in form and detail can be made without departing from the spirit and scope of the present disclosure. The present disclosure should not be limited by any of the above described aspects, but should be defined only in accordance with the following claims and their equivalents.

In addition, it should be understood that the figures, which highlight the structure, methodology, functionality and advantages of the present disclosure, are presented as examples only. The present disclosure is sufficiently flexible and configurable, such that it may be implemented in ways other than that shown in the accompanying figures.

What is claimed is:

1. A collapsible cart for hanging files, the collapsible cart comprising:
a first folding assembly and a second folding assembly, the first folding assembly and the second folding assembly being moveable between a planar deployed position and a folded stored position, each assembly including:
a first vertical elongated leg and a spaced second vertical elongated leg,
a first panel and a second panel,
an inner elongated hinge for pivotally connecting the first panel to the second panel,
a first elongated outer hinge for pivotally connecting the first panel to the first leg,
a second elongated outer hinge for pivotally connecting the second panel to the second leg, all said panels having upper edges closely adjacent the upper ends of said legs,
a first elongated rigid locking member removably connected to the first folding assembly via at least a spaced first pair of connectors respectively on the first and second panels closely adjacent said upper edges,
the elongated rigid locking member being grippable by a hand of a user and forming a handle to maneuver the cart,
a second elongated rigid locking member removably connected to the second folding assembly via at least a spaced second pair of connectors respectively on the first and second panel closely adjacent said upper edges,
the second elongated rigid locking member being grippable by a hand of a user and forming another handle to maneuver the cart, and
a first side and a second side being spaced apart and respectively connected to respective first and second legs of said first and second panels and forming the cart body.

2. The collapsible cart of claim 1, wherein
the first locking member is elongated and U-shaped and slidably receives therein a first top portion of the first folding assembly and extends spanning a space between respective legs; and
the second locking member is elongated and U-shaped and slidably receives therein a second top portion of the second folding assembly and extends spanning a space between respective legs.

3. The collapsible cart of claim 1, wherein the first locking member and the second locking member are planar and extend between the first and second legs of respective first and second folding members, and the first and second locking members each include a handle located medially thereof.

4. The collapsible cart of claim 1, wherein the first locking member includes spaced keyhole slots.

5. The collapsible cart of claim 1, wherein the first locking member and the second locking member include spaced open ended slots extending from the bottom edge of said member upwardly and terminating adjacent a middle portion of said locking member.

6. The collapsible cart of claim 1, wherein a width of the collapsible cart is approximately equal to a filing cabinet width to store hanging files therein.

7. The collapsible cart of claim 1, further including a plurality of wheels at least one being lockable.

8. The collapsible cart of claim 7, further comprising a horizontal unitary lower support removably connected to each of the legs adjacent the wheels and remote from the first and second folding assemblies.

9. The collapsible cart of claim 1, wherein the connectors are headed pins having a respective shank and head spaced outwardly from the first and second panels.

10. The collapsible cart of claim 1, wherein all the hinges are elongated piano hinges.

11. A collapsible cart for hanging files, the collapsible cart comprising:
a first folding assembly and a second folding assembly, the first folding assembly and the second folding assembly being moveable between a planar deployed position and a folded stored position, each assembly including:
a first vertical elongated leg and a spaced second vertical elongated leg,
a first panel and a second panel,
an inner elongated hinge for pivotally connecting the first panel and the second panel,
a first elongated outer hinge connecting the first panel to the first leg,
a second elongated outer hinge connecting the second panel to the second leg,
a first elongated rigid locking member being removably connected to the first folding assembly via at least a spaced first pair of first connectors respectively on the first and second panel on the first folding assembly, the first locking member including an elongated rigid U-shaped member slidably receiving the top portion of the first folding assembly and extending the width of the first folding assembly and a first handle located medially thereof,
a second locking member removably connected to the second folding assembly via a spaced second pair of connectors respectively on the first and second panel of the second folding assembly, the second locking member including a second rigid U-shaped member slidably receiving the top portion of the second folding assembly and extending the width of the second folding assembly and a second handle located medially thereof,
a first side and a second side spaced apart and being parallel and connected to first and second legs to form with the first panels and the second panels a rectangular body of the cart, and
a pair of elongated hanging file channels respectively extending along and attached to a top portion of each of the first and second sides for accommodating hanging files spanning therebetween.

12. The collapsible cart of claim 11, wherein the first folding assembly and the second folding assembly each include
a first caster attached to the first leg and
a second caster attached to the second leg.

13. The collapsible cart of claim 12, wherein at least one of the first caster and the second caster is a locking caster.

14. The collapsible cart of claim 11, further including a horizontal unitary support removably connected to both of the legs of the first folding assembly and the second folding assembly remote from the first and second panels and remote from the hanging file channels.

15. The collapsible cart of claim 14, wherein the horizontal unitary support is a platform for receiving objects thereon.

16. The collapsible cart of claim 11, wherein all of the hinges are elongated piano hinges.

17. The collapsible cart of claim 11, wherein each of the connectors is a headed pin on the panel to connect to respective slots in the locking member.

18. The collapsible cart of claim 17 wherein the slot in the locking member is a keyhole slot.

19. The collapsible cart of claim 11, wherein the first folding assembly and the second folding assembly each include
a first caster attached to the first leg;
a second caster attached to the second leg;
at least one of the first caster and the second caster is a locking caster and a horizontal unitary support removably connected to both of the legs of each of the first folding assembly and the second folding assembly remote from the first and second panels and remote from the hanging file channels.

20. The collapsible cart of claim 19, wherein all of the hinges are elongated piano hinges,
each of the connectors is a headed pin on the panel to connect to a slot in the locking member, and
the slot in the locking member is a keyhole slot.
